(19) United States
(12) Patent Application Publication
(10) Pub. No.: US 2009/0284357 A1
(43) Pub. Date: Nov. 19, 2009

(54) Vehicle wheel security system

(76) Inventors: Jesse Ortega, Stanton, CA (US); Raul Duarte, Westminister, CA (US)

Correspondence Address: RUSSO & DUCKWORTH, LLP., 2nd Floor, 9090 Irvine Center Drive, Irvine, CA, 92618, US

(21) Appl. No.: 12/152,735

(22) Filed: May 16, 2008

(51) Int. Cl. B60Q 1/00

(52) U.S. Cl. 340/425.5

(57) ABSTRACT

An alarm system for automotive wheel rims includes a magnet mounted to each wheel rim mounted substantially at the wheel rim's central axis. Each wheel hub includes a magnetic field sensor for sensing the movement of an adjacent magnet. Each magnetic field sensor is connected to a central processor for transmitting an alarm signal in the event that an adjacent magnet has moved indicating that a wheel rim has been displaced. The central processor triggers an audible or visual alarm alerting persons that a wheel rim has been removed without authorization.

### BACKGROUND OF THE INVENTION

It has long been known to provide vehicles with anti-theft security systems. Typically, the vehicle security systems employ sensors such as motion detectors, vibration detectors, sound detectors, shock sensors, pressure sensors, mechanical switches and/or electrical switches to detect unauthorized intrusion into a vehicle or use of the vehicle. The sensors are typically triggered by a thief opening a door of the vehicle, opening a trunk, breaking a window, opening the vehicle hood, or triggering the vehicle ignition. Upon detection of the attempted theft, the vehicle security device will typically actuate a siren and flash the vehicle lamps to ward off the thief. In addition, the vehicle security system may transmit a radio frequency signal to remotely alert others that an attempted theft has occurred.

Unfortunately, traditional vehicle security systems do not provide independent security to the vehicle's wheels. Thus, a vehicle having a security system protecting the vehicle's doors, trunk, hood, windows and ignition provides no protection for preventing the theft of the vehicle wheels. To steal the wheels from most vehicles, one must simply lift the wheels off the ground using jacks or blocks to allow for removal of the wheels from the vehicle hubs.

Various unsatisfactory constructions have been developed for preventing the unwanted theft of vehicle wheels. These constructions include lug nuts which lock to the hub bolts to inhibit an unauthorized person from removing the wheels. U.K. Patent Application 2,340,976 describes an alarm system for preventing the theft of wheels. The alarm system includes disks mounted on both the wheel and hub. If the disks fail to make electrical contact, an alarm is triggered. Unfortunately, the disks are configured to include holes for receipt of bolts. Since vehicle hubs are constructed with different numbers of bolts and different spacing, different vehicles require different disk constructions. The complicated electrical connection is also prone to failure.

U.S. Pat. No. 7,195,231 describes a security system for preventing the theft of a spare tire and wheel. However, the security system does not provide security for the four wheels which are in use on a vehicle. U.S. Pat. No. 6,774,779 describes a vehicle security system for preventing the unwanted theft of vehicle tires and wheels. The security system includes a pressure module located within each tire. In the event that the sensor detects that tire pressure has decreased more than a predetermined amount, then an alarm is activated. In practice, if a tire is pierced or the vehicle is raised for unwanted removal, the tire pressure will diminish thereby activating the alarm.

Unfortunately, each of the aforementioned security systems suffer from various disadvantages including high costs, substantial complexity and lacking security. It would therefore be desirable to provide a security system for wheel rims which does not require complicated electrical wiring or multiple designs for protecting different wheel rim constructions. Furthermore, it would be desirable to provide a wheel rim security system which was inexpensive to manufacture and easy to install.

### SUMMARY OF THE INVENTION

Briefly, in accordance with the invention, I provide an improved vehicle security system for preventing the theft of vehicle wheel rims. The vehicle security system includes a magnet mounted to the interior surface of the wheel rim at the wheel rim's central axis. Where the wheel rim includes a center cap, the magnet is mounted within the wheel rim cap. The wheel rim security system further includes a magnetic field sensor which detects nearby changes in a magnetic field. The magnetic field sensor is mounted to a vehicle's hub at the hub's central axis at the center point between the hub's bolts. Preferably, though not necessarily, the magnetic field sensor is a simple reed switch. A reed switch is a simple electrical switch consisting of a pair of magnetizable and electrically conductive contacts contained within a hermetically sealed envelope. A magnetic field, such as produced by an adjacent magnet, will cause the electrical contacts to pull together, thus completing an electrical circuit. With the removal of the electrical field, the stiffness of the electrical contacts causes them to separate to open the circuit. Reed switches may also be constructed in the alternative to be in a closed condition in the absence of a magnetic field, but actuated to an open condition by the proximity of a magnet.

Since the wheel rim security system's magnet is affixed to the center of the wheel rim and the magnetic field sensor is mounted to the center of the vehicle hub, the magnet and magnetic field sensor are positioned adjacent to one another so that the magnetic field sensor can detect movement of the magnet relative to the sensor which will occur with the removal of the wheel rim. If the magnet field sensor is a reed switch, the wheel mounted magnet maintains the hub mounted reed switch in a closed or open condition. In the event that the wheel is removed from the hub, the magnet moves away from the magnet field sensor causing the reed switch to switch to the alternative open or closed condition to produce an electrical signal.

The vehicle rim security system further includes a control processor and an audio or visual alarm system. The control processor and alarm system are connected to a power source. The power source may consist of the vehicle's primary battery, or a separate independent battery may be provided for the control processor and alarm system. The alarm system may consist of the vehicle's horn and/or headlights and/or taillights. Alternatively, the security system's alarm system may include independent horns, sirens or other visual or audio alarm constructions known to those skilled in the art.

The magnetic field sensor is connected to the central processor so as to send a signal to the central processor in the event that the magnet has been displaced relative to the adjacent wheel hub. The connection between the central processor and magnetic field sensor may consist of electrical wiring. However, it is preferred that the magnetic field sensor connect to a radio frequency (RF) transmitter and the central processor include a wireless receiver for receiving RF signals from the magnetic field sensor. The magnetic field sensor requires electrical power which may be provided through electrical wiring through the hub to the vehicle's primary battery. However, electrical wiring requires an expensive and complicated construction. Accordingly, it is preferred that the magnetic field sensor be supplied with a replaceable or rechargeable battery.

In operation, in the event that a thief removes the wheel rim from the vehicle, the movement of the magnet affixed to the wheel rim will alter the magnetic field adjacent to the magnetic field sensor. The magnetic field sensor will detect the change in magnetic field and trigger the transmission of an alarm signal to the central processor. In turn, the central processor will activate the alarm system so as to cause an audible siren and/or visual lights to flash. In addition, the alarm system may deactivate ignition power, disable the vehicle fuel supply and/or transmit a radio frequency alert, such as by a cellular telephone system, to the vehicle owner alerting the owner that a theft of his vehicle wheel rims has been attempted.

Various modifications of the vehicle wheel rim security system may be made without departing from the spirit and scope of the invention. For example, preferably the magnetic field sensor periodically transmits a signal to the central processing unit indicating that the magnetic field sensor is operating properly. The signal confirming the operational condition of the sensor may be transmitted continuously, hourly, daily or even weekly.

In addition, wheel rims are constructed with a wide variety of constructions. Thus, the center point of the wheel rim may, or may not, be immediately adjacent to the center of the hub. Accordingly, a lateral extender may be employed to affix the magnet to the wheel rim. The extender may be adjustable in length so as to affix to the interior surface and center point of the wheel rim and extend laterally towards the hub so as to position the magnet immediately adjacent to the magnetic field sensor for proper operation.

It is thus an object of the present invention to provide improved security for a vehicular wheel rim.

It is still an additional object of the present invention to provide a wheel rim security system which is inexpensive to manufacture and easy to install.

These and further objects and advantages of the invention will be apparent to those skilled in the art from the following detailed description taken in conjunction with the drawings.

### BRIEF DESCRIPTION OF THE FIGURES

FIG. 1 is a perspective view illustrating the components of the vehicle wheel security system of the present invention;

FIG. 2 is a perspective exploded view illustrating a magnet for use with the vehicle wheel security system of the present invention;

FIG. 3 is an additional perspective exploded view illustrating an additional embodiment of a magnet for use with the vehicle wheel security system of the present invention;

FIG. 4 is a perspective view illustrating a magnet of the present invention affixed to a wheel cap;

FIG. 5 is an exploded perspective view illustrating the magnet and magnetic field sensor mounted to a wheel cap and wheel hub;

FIG. 6 is a side cutaway view illustrating the magnet and magnetic field sensor for use with the vehicle wheel security system of the present invention affixed to a wheel rim and wheel hub, respectively;

FIG. 7 is a side cutaway view illustrating the magnet and magnetic field sensor of the present invention illustrated in FIG. 6 as a wheel rim is removed from a wheel hub;

FIG. 8 is a perspective view of a vehicle including the vehicle wheel security system of the present invention;

FIG. 9 is a perspective view of a vehicle including a vehicle wheel security system of the present invention as a thief attempts to steal a wheel; and

FIG. 10 is a perspective view illustrating the interior of a vehicle equipped with the vehicle wheel security system of the present invention including a display for displaying the status of wheel rims.

### DETAILED DESCRIPTION OF THE INVENTION

While the present invention is susceptible of embodiment in various forms, as shown in the drawings, hereinafter will be described the presently preferred embodiments of the invention with the understanding that the present disclosure is to be considered as an exemplification of the invention, and is not intended to limit the invention to specific embodiments illustrated.

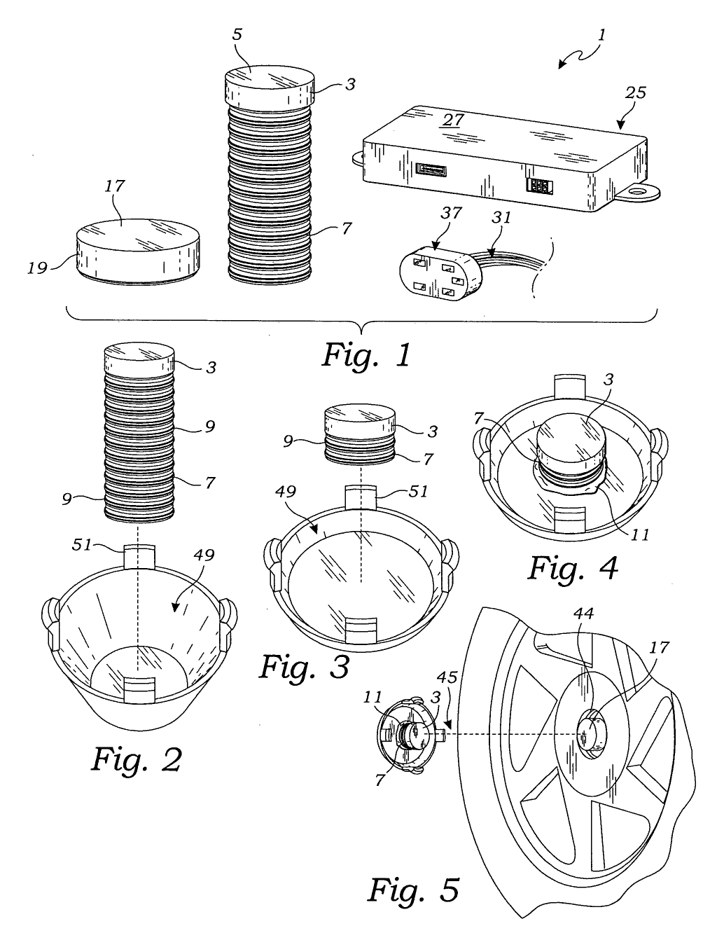

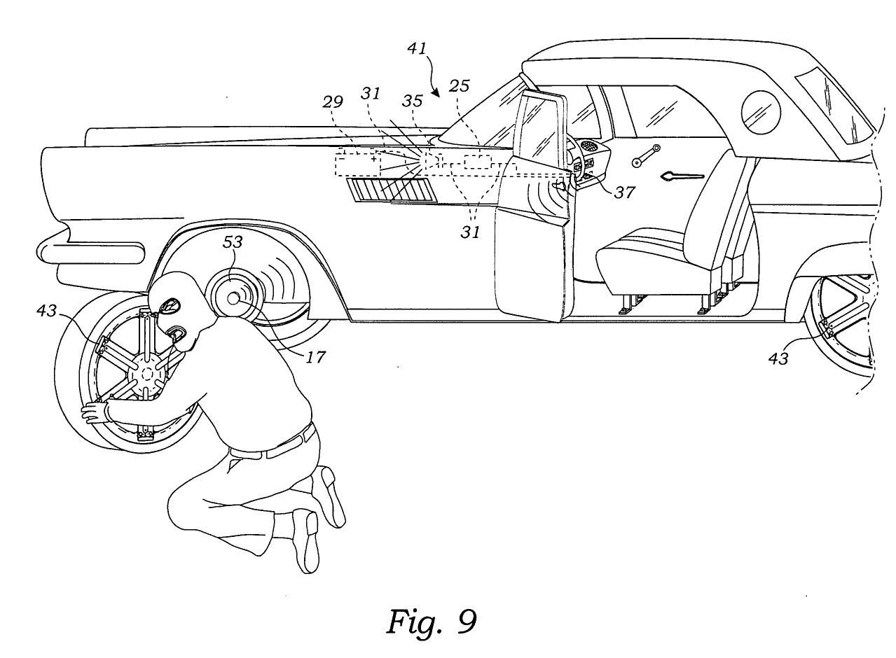

With reference to FIGS. 1-10, the vehicle wheel security system 1 of the present invention provides an alert in the event that a thief attempts to remove the wheel rims 43 from a vehicle 41 without authorization. As best illustrated in FIG. 1, the vehicle wheel security system 1 includes four primary components including magnets 3, magnetic field sensors 17, a central processor 25 and a visual display 37. In addition, the vehicle security system includes a wire harness 31 for connecting the central processor 25 to the display 37, as well as to various vehicle subsystems, as illustrated in FIG. 9.

The vehicle security system includes four magnets 3. Each magnet 3 is affixed to the interior surface of a wheel rim 43 at the wheel rim's central axis 45. Many wheel rims, but not all, will include a removable center cap 47. For simplicity, the figures illustrate wheel rims having a removable center cap 47. However, the wheel security system 1 of the present invention will provide security for wheel rims with or without center caps. As illustrated in FIGS. 4 and 5, each magnet is affixed to the center of a wheel rim 43 or wheel rim center cap 47 utilizing an adhesive 11. Preferably the magnet 3 is encased within a plastic housing 5. Furthermore, since wheel rims and center caps have different constructions, an adjustable extender 7 is provided to affix the magnet 3 to the wheel rim 43 which will enable the installer to adjust the position of the magnet 3 relative to the wheel rim. For example, FIG. 2 illustrates a wheel rim cap 47 having a large central cavity 49, while FIGS. 3 and 4 illustrate wheel caps 47 having shallow cavities 49. As explained in greater detail below, the extender 7 has different lengths to accommodate the different caps for properly positioning the magnet 3. The extender 7 may take various forms. For example, the vehicle security system 1 may be provided with numerous extenders 7 of various lengths. However, in a preferred embodiment illustrated in the figures, each extender 7 includes a plurality of serrations 9 facilitating the removal of a portion of the extender to reduce its length to that which is desired. For example, if the extender length 7 needs to be reduced a small amount, one or two segments can be removed by simply breaking off portions or by cutting off portions utilizing a blade that can be selected by those skilled in the art. Alternatively, the extender 7 can be reduced in length by removing three or more segments until the desired length is achieved.

As best illustrated in FIGS. 5-7, the vehicle security system includes four magnetic field sensors 17 which affix to the vehicle wheel hubs 53 at the hub's central axis 45. The magnetic field sensors 17 may take any of various forms for sensing the movement of the magnet 3 which would cause a movement of the magnetic field. However, preferably the magnetic field sensors are simple reed switches consisting of two electrically conductive metal contacts which are normally in an open condition, but are actuated by a magnetic field from the external magnet 3 to be in a closed condition. Alternatively, the reed switches may be constructed in the alternative to be in a closed condition in the absence of a magnetic field, but actuated to an open condition by the proximity of a magnet 3. Of importance, the magnet 3 must be positioned very close, typically 1 inch or less, to the magnetic field sensor. Accordingly, the extender 7 is sized and cut to an appropriate length for positioning the magnet 7 immediately adjacent to the magnetic sensor 17.

As illustrated in FIGS. 1 and 9, the magnetic field sensors 17 are connected to a central processor 25. The magnetic field sensors may be connected to the central processor through electrical wiring. However, it is preferred that the magnetic sensors 17 be connected to the central processor utilizing RF transmitters (not shown) electrically connected to each magnetic field sensor 17 and an RF receiver (not shown) electrically connected to the central processor 25. Where electrical wiring is not utilized to connect the central processor and magnetic field sensors, the magnetic field sensors and RF transmitter will require an independent power source. Accordingly, preferably the magnetic field sensors 17 and RF transmitters are provided with a replaceable or rechargeable battery which are all encapsulated within an RF and magnetic field translucent housing for protection.

The central processor 25 is also preferably located within a housing 27 which is located somewhere within the vehicle chassis 41. The central processor 25 also includes a power source, which may be the vehicle's primary battery 29 or a separate independent power source. The central processor 25 is also connected to an alarm system for producing an audio and/or visual alert. The alarm system may consist of the vehicle's horn 35 and/or headlights, taillights, turning lights, etc.

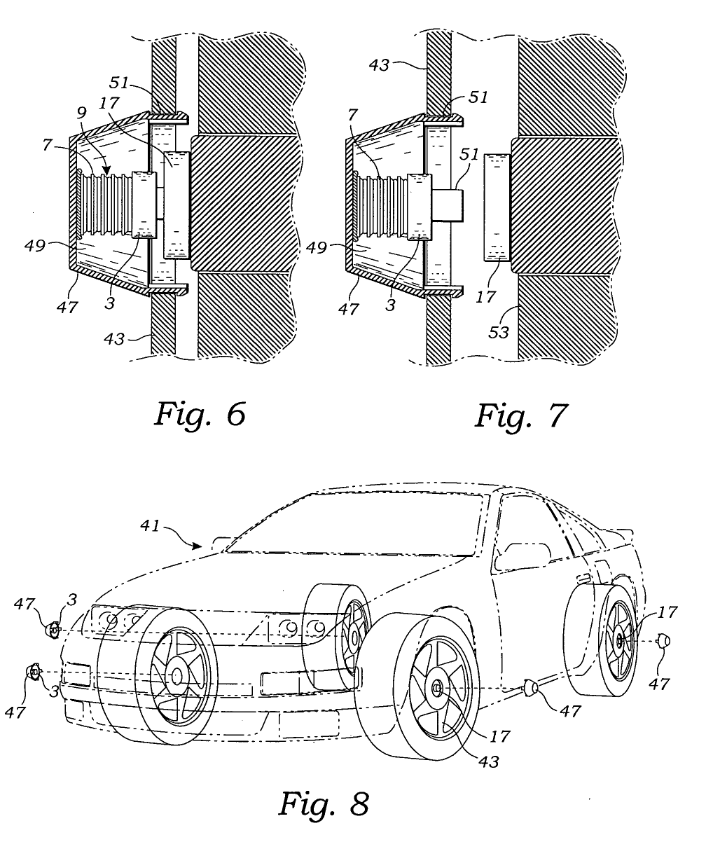

With reference to FIGS. 6-9, in the event that a thief removes a wheel rim 43 from the vehicle hub 53, displacement of the magnet 3 away from the magnetic field sensor 17 will result in the magnetic field sensor sensing the movement of the magnetic field produced by the adjacent magnet 3. In turn, the magnetic field sensor 17 will trigger the transmission of an alarm signal such as through an RF transmitter to an RF receiver connected to the central processor 25. In the event that the vehicle wheel security system 1 is activated, the central processor 25 will trigger an audible or visual alert that a wheel rim 43 has been removed. In addition, the vehicle wheel security system may transmit additional alerts and provide additional security such as disable the vehicle engine or transmit a radio frequency alert to a central office or to the vehicle owner indicating that theft of a vehicle wheel rim is in process.

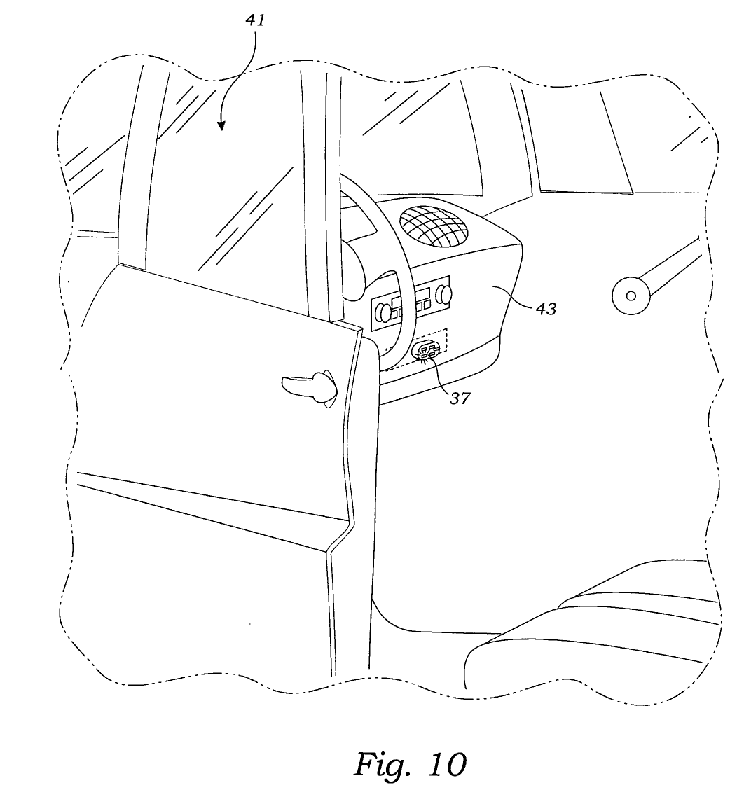

Various modifications of the invention may be made and thus additional features may be introduced to the vehicle wheel security system. For example, as illustrated in FIGS. 9 and 10, the security system may include a dashboard 42 mounted display 37 providing a visual indication as to the status of and/or location of each wheel rim as affixed to the vehicle. For example, the display may provide four or five LEDs indicating that the wheel rim status is good, with the fifth LED providing status for the spare tire. Alternatively, the display may provide numerical, alphabetical or symbolic identification as to identify each wheel rim and the location as to where it is affixed to the vehicle. This feature is considered advantageous for tracking the location of wheel rims such as when vehicle tires are rotated. Preferably the magnetic field sensor periodically transmits a signal to the central processing unit indicating that the magnetic field sensor is operating properly. The operational condition signal may be transmitted hourly, daily or even weekly.

Still additional modifications can be made without departing from the spirit and scope of the invention. Therefore, it is not intended that the invention be limited except by the following claims. Having described my invention in such terms so as to enable persons skilled in the art to understand the invention, recreate the invention and practice it, and having identified the presently preferred embodiments thereof, I claim:

1. An alarm system for automotive wheel rims comprising:
a wheel rim having a central axis;
a magnet mounted to said wheel rim substantially at said wheel rim's central axis;
a vehicle hub including a central axis, said vehicle hub including a plurality of bolts for mounting and affixing said wheel rim to said hub with said wheel rim's central axis coincident with said vehicle hub's central axis;
a magnetic field sensor mounted to said hub substantially at said hub's central axis so as to be substantially adjacent to said magnet, said magnetic field sensor sensing changes in a magnetic field for detecting when said magnet has moved away from said magnetic field sensor; and
an alarm means connected to said magnetic field sensor for causing an audible or visual alarm in the event that said magnetic field sensor detects said magnet moving away from said magnetic field sensor.

2. The alarm system for automotive wheel rims of claim 1 wherein said magnetic field sensor periodically transmits a signal to said alarm system indicating that the magnetic field sensor is operating properly.

3. The alarm system for automotive wheel rims of claim 1 wherein said magnetic field sensor is connected to said alarm means by a radio frequency transmitter connected to said magnetic field sensor and a radio frequency receiver connected to said alarm means.

4. The alarm system for automotive wheel rims of claim 3 wherein said radio frequency transmitter periodically transmits a radio signal to said alarm system indicating that the magnetic field sensor and transmitter are operating properly.

5. The alarm system for automotive wheel rims of claim 1 further comprising an extender mounted between said magnet and said rim for axially moving said magnet so as to be adjacent to said magnetic field sensor.

6. The alarm system for automotive wheel rims of claim 5 wherein said extender has an adjustable length.

7. The alarm system for automotive wheel rims of claim 1 wherein said alarm means transmits an audible or visual alarm in the form of an alert transmitted to a cellular telephone.
